(19) United States
(12) Patent Application Publication
(10) Pub. No.: US 2026/0128626 A1
(43) Pub. Date: May 7, 2026

(54) ELECTRIC MACHINE IN-SLOT COOLING CHANNELS

(71) Applicant: Ford Global Technologies, LLC, Dearborn, MI (US)

(72) Inventors: Nicholas Chase, Royal Oak, MI (US); Wenbo Liu, Ann Arbor, MI (US); Myung Ki Sung, Ypsilanti, MI (US); Seth Avery, Livonia, MI (US); Alfredo R. Munoz, Ann Arbor, MI (US)

(21) Appl. No.: 18/937,374

(22) Filed: Nov. 5, 2024

(51) Int. Cl. H02K 1/20; H02K 1/18

(52) U.S. Cl. CPC H02K 1/20; H02K 1/18

(57) ABSTRACT

A cooling manifold for an electric machine is proposed with a hollow bolt feed solution that takes advantage of an existing bolt structure and interface to a housing of the electric machine to create a fluid passage for routing coolant to internal portions of a stator of the electric machine. The hollow bolt creates a sealed fluid interface without the need to add an additional seal, thereby reducing manufacturing complexity of the electric machine. In-slot cooling with the manifold, or with a plurality of the manifolds, may eliminate a reliance on slot liners and varnish for limiting relative motion of end windings of the stator and providing electrical isolation, while also cooling the hottest part of the electric machine, significantly influencing the machine's thermally limited capability.

### FIELD

The present description relates generally to methods and systems for cooling an electric motor of a vehicle.

### BACKGROUND/SUMMARY

During operation, an electric machine generates electromagnetic losses in the form of heat, which in most cases are focused in a stator of the electric machine. Furthermore, sustained performance of an electric machine is governed by an ability to remove heat coupled with component material temperature limits. Overheating of the electric machine can lead to degraded performance capability, and eventually, degradation of the electric machine. The inventors herein have developed systems and methods to at least partially address overheating of the electric machine.

In particular, the hottest part of the electric machine (e.g., the thermally limiting hot spot) is the windings at the center of the stator, which may not directly receive coolant supplied by the existing cooling solutions. Directly cooling the hot spot may allow for higher power density and may increase continuous performance, as compared with the existing cooling solutions. In one example, the direct cooling of the windings may be accomplished by a cooling system for an electric machine having a stator and a housing, the cooling system comprising a cooling manifold positioned at an axial center of the stator and aligned coaxially with a central axis of stator; and a bolt clamping the stator to the housing, the bolt including a hollow section comprising a fluid inlet and a fluid outlet configured to transfer a coolant from the hollow section into a plurality of passages of the cooling manifold. The coolant may be flowed from the housing to the cooling manifold through the hollow section, and subsequently directed to end windings of the stator via radial passages that extend into winding slots of the stator. The coolant may also circulate from an inlet of the cooling manifold to all the radial passages via circumferential passages within the manifold.

In other words, a plurality of passages may be incorporated into the stator that allow the coolant to flow between the stator core and windings, for direct hot spot cooling while meeting mechanical retention demands. In an electric machine, mechanical retention between a stator core and a housing of the electric machine may be relied on to provide reaction torque. Two common methods for stator retention are using bolts (through ears located outside of a stator yoke) and an interference fit (between the stator core and housing), in which no bolts are used. While interference fits are beneficial for noise, vibration, and harshness (NVH) and creating fluid interfaces to the stator core, bolts are often preferred due to increased core losses caused by compressive stresses of an interference fit. Thus, while using bolts for stator retention to minimize core losses, the hollow bolt presents a novel interface for introducing the coolant to the center of the electric machine.

In this way, one or more fluid manifold(s) with hollow bolt feeds take advantage of an existing bolt and interface to the housing to create a fluid passage to the windings of the stator. The hollow bolt creates a sealed fluid interface without having to add an additional seal, thereby reducing manufacturing complexity of the electric machine. Mechanical retention is also used within the slots between the stator windings and the stator core to prevent relative motion that can lead to insulation degradation. Slot liners and varnish may be used to limit this relative motion and provide electrical isolation. As a result, in-slot cooling with the manifold(s) may eliminate the use of slot liners and varnish, while still reducing relative motion and cooling the hottest spot of the machine, reducing manufacturing resources and complexity while increasing the machine's thermally limited capability.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a first perspective view of a portion of an exemplary electric machine including a hollow bolt and a cooling manifold;

FIG. 2 is a cross-sectional view of the electric machine;

FIG. 3 is a perspective view of the electric machine showing an isometric view of the cooling manifold;

FIG. 4 is an in-plane cross-sectional view of the cooling manifold;

FIG. 5 is an expanded view of the in-plane cross-sectional view of FIG. 4;

FIG. 6 is a circumferential cross-sectional perspective view of the cooling manifold;

FIG. 7 is an in-plane cross-sectional perspective view of a portion of the cooling manifold;

FIG. 8 shows a portion of an example of the cooling manifold that is stamped;

FIG. 9 is a perspective view of a portion of the electrical machine including the stamped cooling manifold, showing an exemplary circumferential pocket;

FIG. 10 is a perspective view of the electric machine showing a fluid passage;

FIG. 11 shows a portion of the electric machine including end windings of a stator of the electric machine;

FIG. 12 shows an example of the electric machine in which a first end ring manifold is included on a first end of the stator, and a second end ring manifold is included on a second end of the stator;

FIG. 13 shows an expanded view of the first end ring manifold;

FIG. 14 shows an example of the electric machine where the stator has an interference fit to a housing of the electric machine;

FIG. 15 shows an expanded portion of the electric machine of FIG. 14, including an interface between the cooling manifold and a plurality of windings of the stator;

FIG. 16 shows an example of the electric machine including a circumferential channel of the cooling manifold; and

FIG. 17 schematically shows an example vehicle powertrain that may comprise an electric machine, in accordance with the present disclosure.

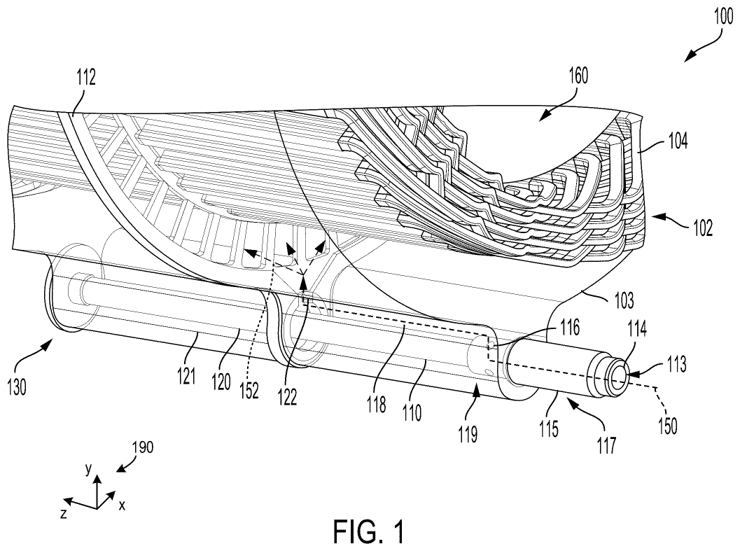

FIGS. 1-16 are shown to scale, although other relative dimensions may be used, if desired.

### DETAILED DESCRIPTION

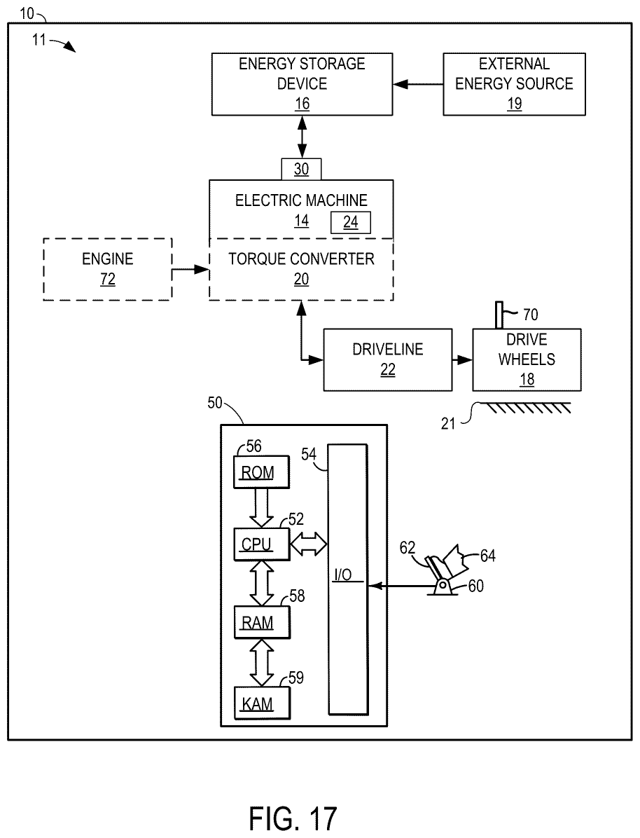

Systems and methods are described herein for cooling an electric machine of a vehicle, specifically by cooling windings at the center of a stator of the electric machine, the hottest part of the electric machine, which may not directly receive coolant supplied by existing cooling solutions. An electric machine with the cooling system of the present disclosure may be incorporated into an exemplary vehicle shown schematically in FIG. 17. FIG. 17 is described first, to provide an overview of vehicle systems including the electric machine. The cooling of the electric machine is then described in relation to FIGS. 1-16.

Turning first to FIG. 17, an example of a vehicle 10 with a propulsion system 11 (e.g., electric propulsion system) is shown. Propulsion system 11 includes an electric machine 14 (e.g., energy conversion device). The electric machine 14 may be incorporated into an axle of the vehicle 10 and may comprise an in-slot cooling system 24 according to the present disclosure. The electric machine 14 is controlled via controller 50. In some examples, the vehicle propulsion system 11 may further include an engine 72, where the engine 72 may be an internal combustion engine.

The electric machine 14 is further shown coupled to an energy storage device 16, which may include a battery (e.g., traction battery), a capacitor, inductor, or other electric energy storage device. The electric machine 14 can be operated to convert mechanical energy received from the vehicle driveline into a form of energy suitable for storage by the energy storage device (e.g., provide a generator operation). The electric machine 14 can also be operated to supply an output (power, work, torque, speed, etc. ,) to drive wheels 18 (e.g., provide a motor operation). It should be appreciated that the electric machine 14 may, in some examples, function only as a motor, only as a generator, or both a motor and generator, among various other components used for providing the appropriate conversion of energy between the energy storage device and the vehicle drive wheels. For instance, the electric machine 14 may include a motor, a generator, integrated starter generator, starter alternator, among others and combinations thereof. The electric machine 14 may also include or be coupled to an inverter 30. The inverter 30 may be configured to condition electrical energy in and out of the energy storage device (e.g., high voltage battery). However, in other examples, the vehicle may not include an inverter.

The energy storage device 16 may be selectively coupled to an external energy source 19. For example, the energy storage device 16 device may be periodically coupled to a charging station (e.g., commercial or residential charging station), portable energy storage device, etc., to allow the energy storage device 16 to be recharged.

In examples where the electric machine is a hybrid vehicle, the electric machine 14 may be coupled to a torque converter 20. The torque converter 20 is a fluid coupling designed to transfer rotational input from the electric machine 14 to a driveline 22. In the hybrid examples, the driveline 22 includes a transmission with gearing and other suitable mechanical components (e.g., a gearbox, axles, transfer cases, etc.) designed to transfer rotational motion to the drive wheels 18. The drive wheels 18 may be supported by and drive vehicle 10 across a surface 21. The torque converter 20 and the electric machine 14 are depicted as an interconnected unit. However, in other examples, the torque converter 20 and the electric machine 14 may include discrete enclosures.

The electric machine 14 may include one or more clutches designed to selectively rotationally couple the rotor of the electric machine 14 to the torque converter 20. For instance, the clutch or clutches may each include plates, splines, and/or other suitable mechanical components allowing the machine to be rotationally connected as well as disconnected from the engine 72 or the torque converter 20.

The depicted connections between electric machine 14, driveline 22, and drive wheel 18 indicate transmission of mechanical energy from one component to another, whereas the connections between the electric machine 14 and the energy storage device 16 may indicate transmission of a variety of energy forms such as electrical, mechanical, etc. For example, torque may be transmitted from the electric machine 14 to drive the vehicle drive wheels 18 via the driveline 22. As described above, the electric machine 14 may be configured to operate in a generator mode and/or a motor mode. In a generator mode, propulsion system 11 receives some or all of the output from electric machine 14, which reduces the amount of drive output delivered to the drive wheel 18, or the amount of negative torque to the drive wheel 18. Operations of the vehicle 10 that use the generator mode may be employed, for example, to achieve energy efficiency gains through regenerative negative torque, increased engine efficiency (if included), etc. Further, the output received by the electric machine 14 may be used to charge the energy storage device 16. In motor mode, the electric machine 14 may supply mechanical output to the driveline 22, for example by using electrical energy stored in an electric battery. Additionally, the engine 72 may supply rotational output to the driveline 22, in some instances.

The electric machine 14 may also be used to deliver electrical energy to external, auxiliary devices during power take-off. The electric machine 14 may run during power take-off when the drive wheels 18 are not in motion, allowing power output from the electric machine 14 to be directed at least partially towards operating the auxiliary devices.

In examples where the vehicle 10 comprises engine 72, engine 72 may have an output coupled to the torque converter 20 and may be incorporated into the axle of the vehicle. The engine 72 may be controlled via a controller 50. Both the engine 72 and electric machine 14 may act as movers to drive the vehicle 10. For example, the vehicle 10 may be a hybrid vehicle. In examples including engine 72, rotational energy in the form of torque from the engine 72 or other rotational and mechanical energy from components may be converted into electrical energy by the electric machine 14. The output of the electric machine 14 to the torque converter 20 may act as an input for the transfer and transformation of torque into electrical energy during hybrid operations.

The controller 50 receives signals from various sensors of FIG. 17 and employs the various actuators of FIG. 17 to adjust vehicle operation based on the received signals and instructions stored in non-transitory memory of the controller 50. Specifically, controller 50 is shown in FIG. 17 as a conventional microcomputer including: microprocessor unit 52, input/output ports 54, read-only memory 56, random access memory 58, keep alive memory 59, and a conventional data bus. Controller 50 is configured to receive various signals from sensors coupled to the propulsion system 11 and send command signals to actuators in components in the vehicle, such as the electric machine 14. Additionally, the controller 50 is also configured to receive pedal position (PP) of a pedal 62 actuated by a user 64. The PP may be estimated by and received from a pedal position sensor 60 coupled to the pedal 62. Therefore, in one example, the controller 50 may receive a pedal position signal and adjust actuators in the electric machine 14 based the pedal position signal to vary the rotational output of the electric machine 14. The sensors communicating with the controller 50 may include an electric machine sensor (e.g., resolver or Hall effect sensor for sensing a rotor position of the electric machine), and wheel speed sensor 70, accelerometer, etc. The controller 50 may send commands to a pump (not shown) to control pressure and flow rate of coolant fluid flowing through the in-slot cooling system 24 of the electric machine 14.

The electric machine 14 may comprise a rotor and a stator, wherein the stator circumferentially surrounds the rotor with a gap maintained therebetween. Conductors (e.g., windings, copper wires) adapted to generate a magnetic field in order to rotate the rotor may extend through the stator. The conductors may be susceptible to excessive heat due at least in part to high electrical power. Thus, the in-slot cooling system 24 may be employed to reduce a temperature of the conductors. For example, the in-slot cooling system 24 in accordance with the present disclosure may include coolant fluid flowing within slots (e.g., through holes) in the stator wherein the conductors are positioned. Thus, coolant fluid may surround a full length of the conductors, thereby increasing cooling effects of the coolant fluid compared to systems wherein coolant contacts only the ends of the conductors not within the stator. In particular, the in-slot cooling system 24 may channel the coolant fluid (also referred to herein as coolant) to portions of the stator via a hollow stator bolt, as described below in reference to FIG. 1.

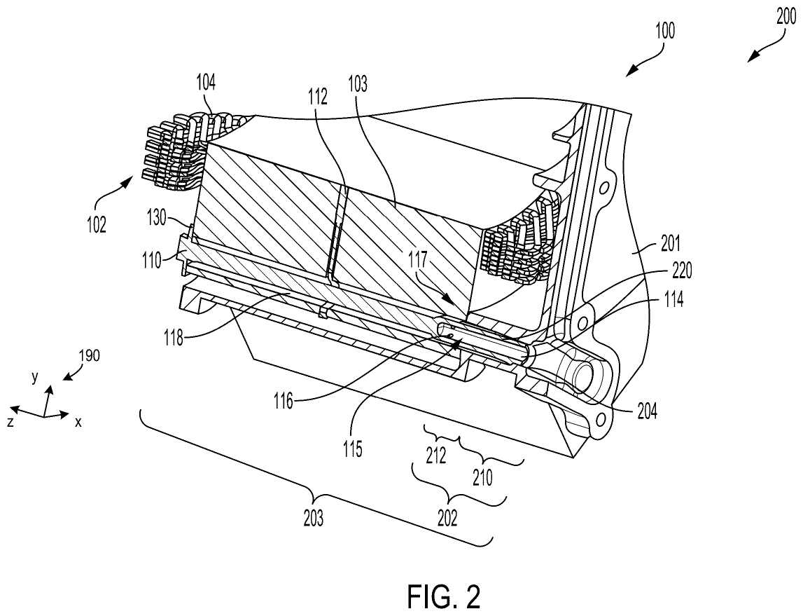

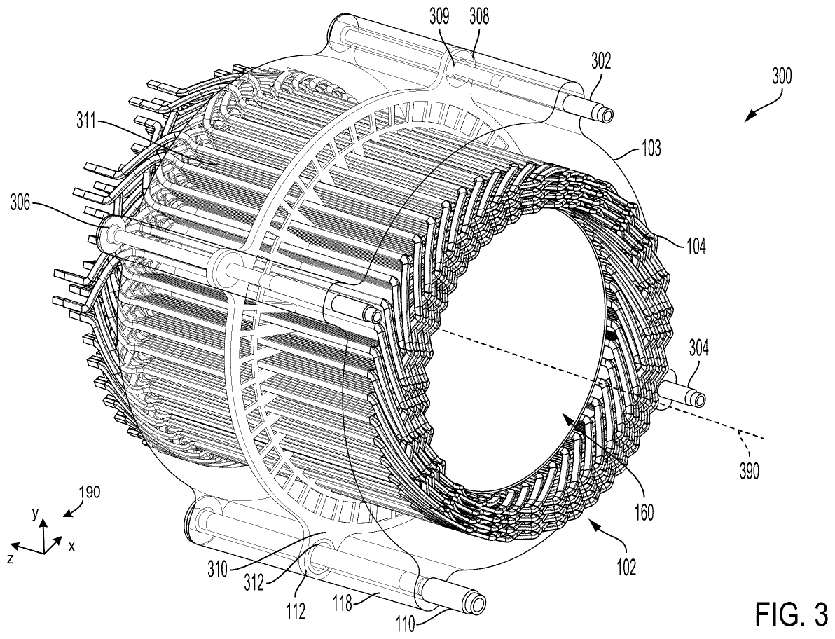

Referring now to FIG. 1, a first perspective view of a portion of an electric machine 100 is shown, including a stator 102. Stator 102 comprises a plurality of windings 104, through which a current is introduced to generate a magnetic field used to rotate a rotor (not depicted in FIG. 1) positioned in an air gap 160 within stator 102. Stator 102 may be positioned within a stator core 103 of electric machine 100, which is transparent in FIG. 1. Stator core 103 is secured to a housing of electric machine 100 via a plurality of bolts, as shown in FIGS. 2 and 3. A set of reference axes 190 is shown depicting an alignment of electric machine 100, which is also shown in FIGS. 2-16.

In particular, electric machine 100 includes a hollow bolt 110, which may be positioned at one side of stator 102 and aligned parallel with a central axis of stator 102 (as shown in FIG. 3). Hollow bolt 110 may be similar to bolts typically used to clamp stator 102 to the housing. However, bolt 110 may serve a dual purpose of both clamping stator 102 and providing a coolant passage 113 to a plurality of axial positions of stator core 103.

During operation of electric machine 100, heat may accumulate in electric machine 100, where the heat may be greatest at the windings 104, which may be referred to herein as a winding hot spot. To cool the winding hot spot, a coolant, such as oil, automatic transmission fluid, dielectric fluids, etc., may be fed to stator 102 via a coolant passage 113 of hollow bolt 110. Specifically, hollow bolt 110 may include a hollow threaded bolt section 115, where hollow bolt 110 threads into the housing. A first portion 117 of hollow threaded bolt section 115 may extend into the housing. A second portion 119 of hollow threaded bolt section 115 may extend into stator core 103. Second portion 119 may include one or more radial holes 116 positioned around a circumference of sides of hollow threaded bolt section 115. For example, four radial holes 116 may be positioned around the circumference and separated by equal distances. Radial holes 116 may allow the coolant to flow from a center passage 113 of hollow threaded bolt section 115 to a passage 118 between a stator core ear hole 121 and an outer circumference 120 of hollow bolt 110. Passage 118 created by hollow bolt 110 and stator core ear hole 121 is sealed to a head 130 of bolt 110 and the housing by a clamping force of bolt 110.

A flow of the coolant through hollow bolt 110 is indicated by an arrow 150. The coolant may enter hollow bolt 110 via an aperture 114 of hollow bolt 110. The coolant may flow through the first portion 117 of hollow threaded bolt section 115, and into the second portion 119. The coolant may exit hollow threaded bolt section 115 into passage 118 via the one or more radial holes 116 of second portion 119. The coolant may flow along passage 118 (e.g., between an outer edge of hollow bolt 110 and an inner edge of stator core ear hole 121. The coolant may flow from passage 118 to an in-slot cooling manifold 112 positioned at an axial center of stator 102, via an aperture 122 in cooling manifold 112. Manifold 112 may distribute the coolant circumferentially around stator 102 and radially inward towards a center of stator 102, in a direction generally indicated by a plurality of arrows 152. As described in greater detail below, the coolant may circulate around and cool windings 104 located at the center of stator 102, unlike other alternative cooling solutions that rely on circulating a coolant around a surface of stator 102.

FIG. 2 shows a cross-sectional view 200 of electric machine 100 of FIG. 1, where a full extent of hollow bolt 110 and hollow threaded bolt section 115 can be seen, from head 130 to a housing 201 of electric machine 100. Hollow threaded bolt section 115 has a length 202, which may be shorter than a length 203 of hollow bolt 110. Length 202 may be divided into two components: a first component length 210 corresponding to a length of first portion 117 that extends into housing 201, and a second component length 212 corresponding to second portion 119 of hollow threaded bolt section 115 that extends into stator core 103. In some examples, first component length 210 may be greater than second component length 212. First component length 210 may be selected such that radial holes 116 are positioned between lip 220 and cooling manifold 112 positioned at the axial center of stator core 103, such that the coolant may easily flow from within hollow threaded bolt section 115 to passage 118. Hollow bolt 110 may include a lip 220 around an outer circumference of hollow bolt 110, which may seal passage 118 at an interface between housing 201 and stator core 103.

Hollow bolt 110 is connected to a passage 204 of housing 201 via aperture 114, through which the coolant may be supplied. The coolant may be supplied by a coolant pump positioned downstream from a coolant cooler and filter, which are not depicted in FIG. 2. The coolant pump may also distribute the coolant to the rotor of electric machine 100 to cool magnets of the rotor, in some examples. In other examples, passage 118 could additionally or alternatively be fed by a banjo eye under the bolt head (not depicted in FIGS. 1 and 2). Additionally, it should be appreciated that in some examples, electric machine 100 may include a plurality of hollow bolts 110, each hollow bolt 110 connecting to a passage 204 supplied by the coolant pump. For example, in one example, all bolts used to clamp stator 102 to housing 201 may be hollow bolts 110.

Referring now to FIG. 3, a perspective view 300 of electric machine 100 is shown, where bolt 110 is aligned parallel with a central axis 390 of stator 102. Perspective view 300 shows an isometric view of manifold 112. Manifold 112 is supported by bolts 302, 304, 306, and hollow bolt 110 of FIGS. 1 and 2. Each of bolts 302, 304, 306, and 110 pass through a bolt hole eyelet 308 of a respective bolt hole 309 of manifold 112, to provide a rigid clamping path between the heads of bolts 302, 304, 306, and hollow bolt 110 and housing 201, and allow the main body of manifold 112 to be made of inexpensive and easily manufactured materials, such as injection molded plastic. Bolt hole eyelets 308 may include dowel features (e.g., lips on the eyelets, or plastic features that extend partially into portions of slot opening) that align manifold 112 to a plurality of stator core slots 311 of stator core 103. Manifold 112 may supply the coolant from passage 118 through a radial inlet at a location 310 of manifold 112 from a partially open compression limiting eyelet 312, described in greater detail below. It should be appreciated that in other examples, one or more, or all of bolts 302, 304, and 306 may be hollow bolts such as hollow bolt 110, and the coolant may be delivered to windings 104 of stator 102 via all of the hollow bolts in a similar manner.

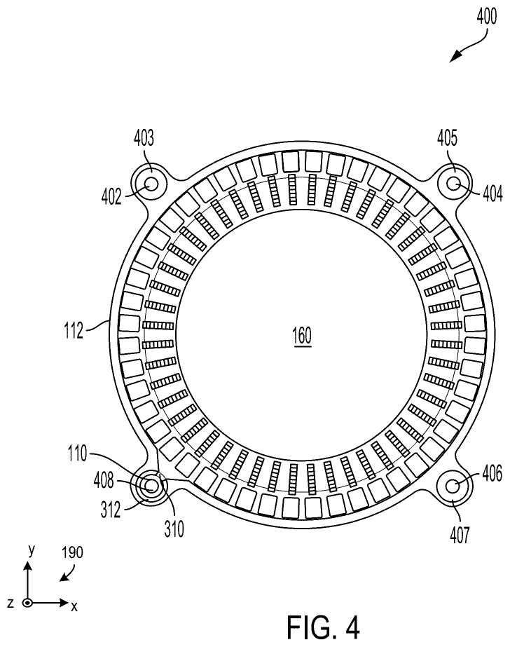

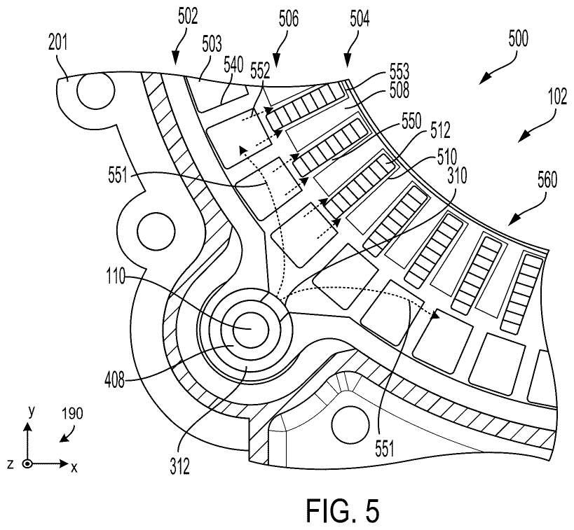

FIG. 4 is an in-plane cross-sectional view 400 of cooling manifold 112, showing a first bolt hole 402 with a respective bolt hole eyelet 403; a second bolt hole 404 with a respective bolt hole eyelet 405; a third bolt hole 406 with a respective bolt hole eyelet 407; and a fourth bolt hole 408 with compression limiting eyelet 312, where each of eyelets 403, 405, and 407 are non-limiting examples of bolt hole eyelet 308 of FIG. 3. While four bolt holes/eyelets are depicted in FIG. 4, it should be appreciated that in other examples, a greater or lesser number of stator bolts may be used. In some examples, one or more of eyelets 403, 405, and 407 may be compression limiting eyelets 312, to accommodate a plurality of hollow bolts 110. In-plane cross-sectional view 400 may be injection molded as a single component. Features of cross-sectional view 400 are described in greater detail in reference to FIG. 5.

Referring to FIG. 5, an expanded view 500 of cross-sectional view 400 of FIG. 4 shows compression limiting eyelet 312, through which hollow bolt 110 passes. Expanded view 500 shows three circumferential sections of manifold 112, including a first circumferential section 502, a second circumferential section 504, and a center circumferential section 506. First circumferential section 502 and second circumferential section 504 distribute the coolant circumferentially around the stator to a plurality of winding slots 510 in which a plurality of windings 512 (e.g., windings 104) are positioned.

Center circumferential section 506 of manifold 112 includes a plurality of radial ribs 508, where each radial rib 508 is a mechanical retention feature that connects first circumferential section 502 to second circumferential section 504, such that manifold 112 can be molded as a single part, without having to align multiple pieces. The overall axial thicknesses of manifold 112, rib 508, and dimensions of hole 408 may vary based on optimization and a specific application. Additionally, center circumferential section 506 of the manifold may have a close fit or interference fit to a set of windings 512 (e.g., windings 104) of winding slots 510 to provide mechanical support to prevent an outer enamel coating of windings 104 from rubbing on the stator core. Features of manifold 112 that interface to windings 512 may be the same material as the rest of manifold 112, or may be made of a softer over-molded material (e.g., rubber).

These winding interface features combined with the manifold ribs 508 structurally connect winding slots 510 to the clamped-in-place eyelets. Manifold 112 is sealed against laminations of the stator core axially by a compression of bolts 302, 304, 306, and hollow bolt 110. Sealing features (e.g., plastic ribs or seals and seal grooves) and/or flexible soft polymer manifold material may be included to provide adequate sealing.

The coolant distributed to manifold 112 via hollow bolt 110 may flow along a path indicated by arrows 551, (e.g., arrows 152 of FIG. 1). The coolant may flow radially from hollow bolt 110 to an internal surface 560 of stator 102 (which seals the air gap such that coolant only flows to the slots) between a plurality of ribs 508. The coolant may then flow axially to end windings 512 via the winding slots 510. The coolant may also flow circumferentially around stator 102 at the first circumferential section 502 and second circumferential section 504 in either or both of a clockwise and a counterclockwise direction around stator 102.

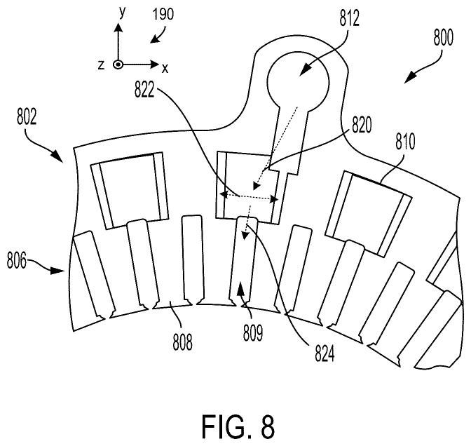

More specifically, manifold ribs 508 may be configured to provide a series of interconnected passages 550 that extend around an edge of each winding slot 510, to allow coolant to circulate around windings 512 both axially and radially. That is, in the cross-sectional x-y plane shown in FIG. 8, as indicated by reference axes 190, the coolant may enter the passages 550 radially as indicated by a plurality of radial arrows 552. The coolant may be routed circumferentially around an end portion 553 of each passage 550. The coolant may also be routed in between and along the windings 512 where passages 550 extend in an axial direction, along the z axis indicated in reference axes 190. Similarly, at first circumferential section 502 and second circumferential section 504, the coolant may also be distributed axially in the same manner through passages around a plurality of edges 540 of portions of a stator core 503 (e.g., stator core 103), to access the plurality of winding slots 510 at different axial positions along each winding slot (e.g., at different locations along the z axis and the length of the stator core 503.

In this way, the coolant may be directed efficiently around the windings 512 of each winding slot 510. By directing the coolant along the passages 550 radially, circumferentially, and axially around and along each winding slot 510, an amount of heat transferred from the windings 512 of the winding slot 510 to the coolant may be increased in comparison to other cooling solutions that direct the coolant at other surfaces of stator 102.

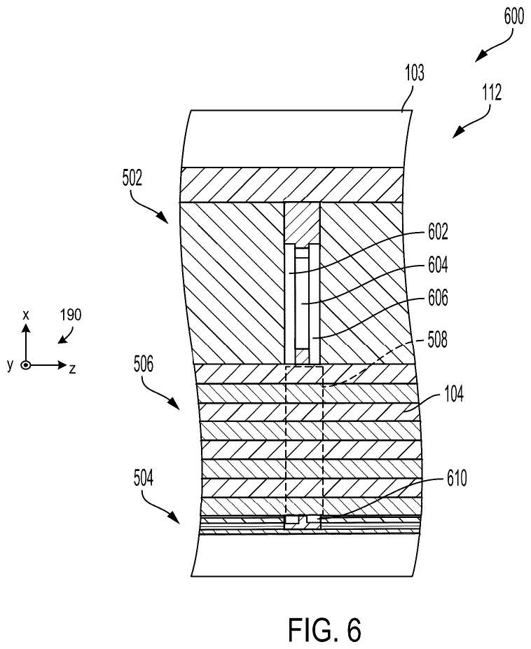

FIG. 6 shows a circumferential cross-sectional perspective view 600 of manifold 112, where windings 104 partially obscure rib 508 at center circumferential section 506 of manifold 112. Coolant may flow circumferentially around manifold 112, and may be directed radially into a first passage 602 and a second passage 606, which may be non-limiting examples of the passages 550 of FIG. 5. The coolant may be directed axially through the winding slots, meaning, in a direction along the z axis of reference axes 190. The coolant may also be directed axially through the winding slots along a set of passages 610 of manifold 112 (e.g., at second circumferential section 504, adjacent to air gap 160). The coolant may additionally flow circumferentially around the electric machine and radially, from first circumferential section 502 to second circumferential section 504 and/or from second circumferential section 504 to first circumferential section 502, via spaces 604 between the ribs 508. In other words, each winding slot (e.g., winding slots 510) is fed from first passage 602 and second passage 606 radially in a small gap between the windings 104 and manifold 112.

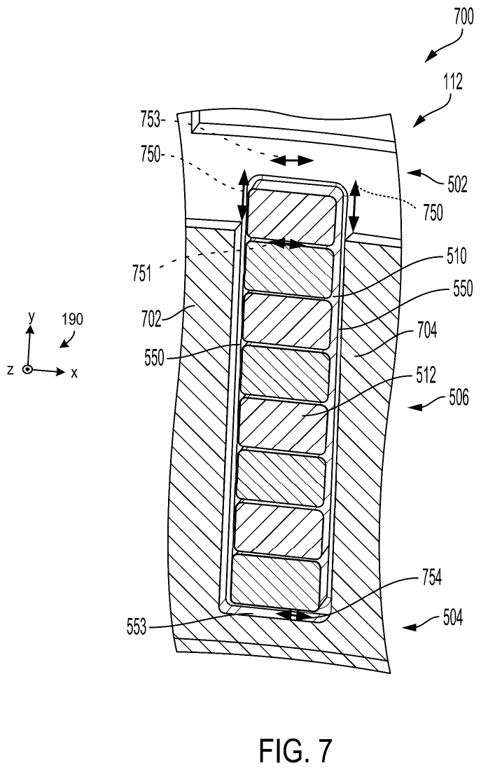

FIG. 7 shows an in-plane cross-sectional perspective view 700 of a portion of manifold 112 including passages 550 that surrounds windings 512 within a winding slot 510. The coolant circulates from first circumferential section 502 to second circumferential section 504 through a first passage 550 between a first rib 702 of manifold 112 at center circumferential section 506 and the windings 512, and through a second passage 550 between a second rib 704 of manifold 112 and the windings 512 at center circumferential section 506. A direction of flow of the coolant through the first passage 550 and the second passage 550 is indicated by a set of arrows 750. The flow may be directed either up or down the first passage 550 and the second passage 550, and may be directed either from first rib 702 to second rib 704 or from second rib 704 to first rib 702 between each of the windings 512 and at end portion 553 of the passages 550 as indicated by arrows 751 and 754, respectively. For example, the coolant may flow down the first passage 550 from first circumferential section 502 to second circumferential section 504, from first rib 702 to second rib 704 between the windings 512 and at the end portion 553, and up the second passage 550 from second circumferential section 504 to first circumferential section 502. The coolant may also be flowed circumferentially around the stator core at first circumferential section 502, as shown by arrow 753.

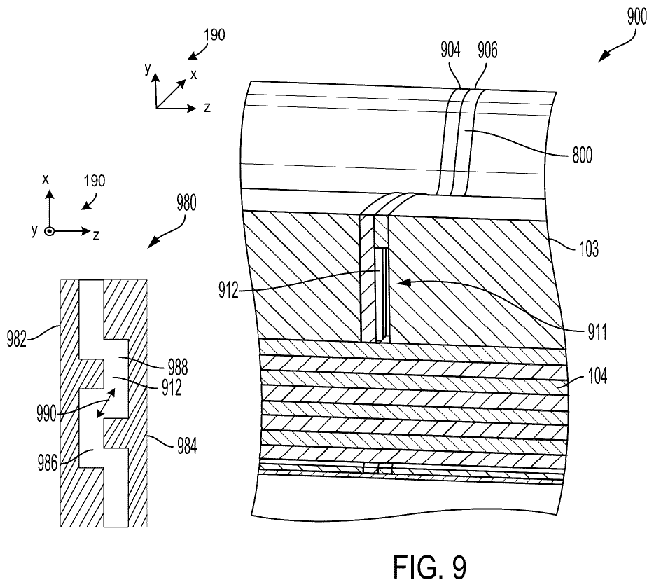

As shown in FIGS. 8 and 9, in some examples, manifold 112 may be created from one or more different materials with stampings, for example, using two different stampings or sub stacks of laminations. For example, the one or more different materials may include electrical steel, aluminum, or a different material.

Referring to FIG. 8, a portion of a stamped cooling manifold 800 is shown, where stamped cooling manifold 800 may be a non-limiting example of manifold 112 of FIGS. 1-6, in accordance with an example. Stamped cooling manifold 800 includes a first circumferential section 802 and a second circumferential section 806, which may be the same as or similar to first circumferential section 502 and center circumferential section 506 of manifold 112. As described in reference to FIG. 5, second circumferential section 806 may include a plurality of ribs 808 (e.g., ribs 508) that allow the coolant to circulate around a winding slot 809, where a plurality of windings may be positioned between and partially or fully enclosed by ribs 808. To accommodate the winding slots 809, stamped cooling manifold 800 may include a plurality of cut-out sections. Stamped cooling manifold 800 also includes a second plurality of cut-out sections 810, which may allow a coolant to flow circumferentially in a serpentine pattern between alternating and connected circumferential pockets created by the cut-out sections 810 of each lamination, as shown in greater detail in FIG. 9. That is, the coolant may flow into the cut-out sections 810 as indicated by an arrow 820, then flow circumferentially through the alternating and connected circumferential pockets as indicated by a bidirectional arrow 822; and also flow from the pockets into each winding slot 809 radially, as indicated by an arrow 824. The alternating and connected circumferential pockets may be added to the two sub stacks allow the coolant to be distributed circumferentially while still maintaining a continuous lamination. The pockets in the lamination can be connected to a fluid passage of the hollow bolt (e.g., passages 113 and 118) similar to the plastic manifold 112 described in reference to FIGS. 1-7. As described above, the coolant may be introduced into stamped cooling manifold 800 via a hollow bolt (e.g., hollow bolt 110) that passes through a bolt hole 812 of stamped cooling manifold 800 (e.g., fourth bolt hole 408 of FIG. 4).

FIG. 9 shows a perspective view 900 of a portion of electric machine 100 of FIG. 1 including stamped cooling manifold 800. An exemplary circumferential pocket 912 is also shown. In FIG. 9, stamped cooling manifold 800 comprises a first sub stack 904 laminated to a second sub stack 906. To create circumferential pocket 912, a portion of second sub stack 906 has been removed at a location 911. Circumferential pocket 912 may be one of a plurality of overlapping circumferential pockets (not shown in FIG. 9) of stamped cooling manifold 800, such that coolant leaving one circumferential pocket may flow into a different circumferential pocket of an opposite sub stack. For example, circumferential pocket 912 may overlap with a second circumferential pocket created by removing a portion of first sub stack 904.

An expanded portion 980 of perspective view 900 shows a simplified alignment of a first portion 982 of first sub stack 904 with a second portion 984 of second sub stack 906, to create circumferential pocket 912, which extends circumferentially around the stator (e.g., in the x direction). As can be seen, removed portions of first sub stack 904 and second sub stack 906 are aligned such that coolant may flow to and from a first recessed portion 986 of first sub stack 904 into a second recessed portion 988 of second sub stack 906, as indicated by an arrow 990. The coolant may additionally flow radially along the y axis between different portions of the stator. In this way, the coolant follows a serpentine path through a middle portion of the stator in which sub stacks 904 and 906 are positioned, where the serpentine path connects with the passages 550 (not shown in FIG. 9) around the windings 104.

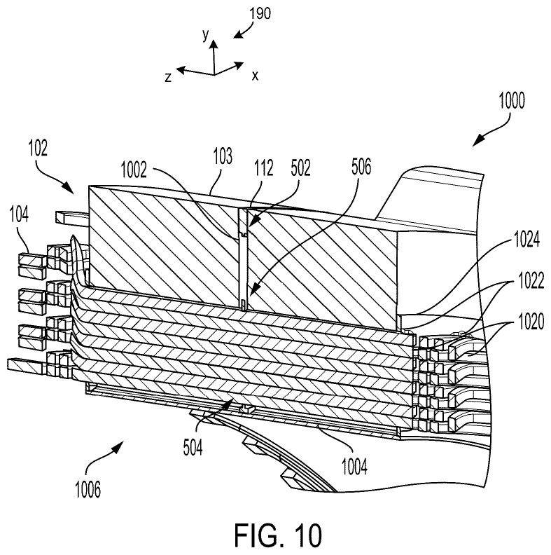

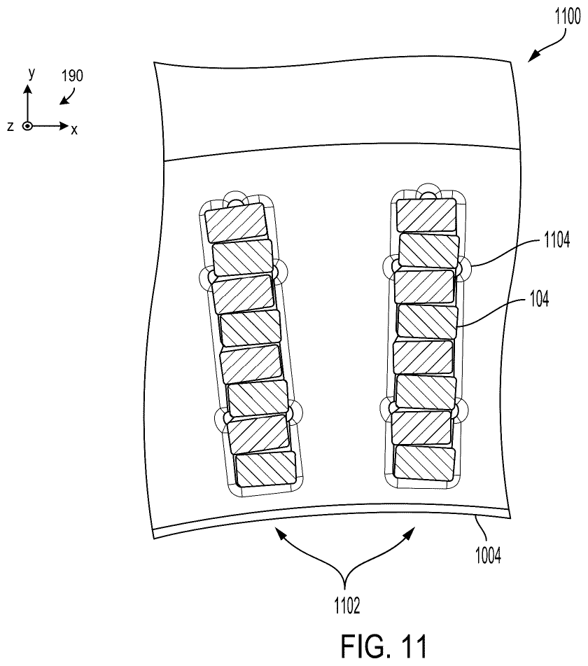

FIG. 10 shows a perspective view 1000 of electric machine 100 of FIG. 1 similar to cross-sectional perspective view 600 of FIG. 6, where an in-slot fluid passage 1002 extends from first circumferential section 502 to second circumferential section 504 (obscured by a set of windings 104 (e.g., of winding slots 510) of manifold 112 via a rib 508 at center circumferential section 506 (also obscured by the set of windings 104). To seal in-slot fluid passage 1002 from leaking coolant into a machine air gap 1006 between stator 102 and the rotor, a seal sleeve 1004 is added circumferentially at an inner diameter of stator 102. Seal sleeve 1004 may be an over molding (e.g., plastic or epoxy), or a glued in-place sleeve, such as a carbon fiber sleeve. Additionally, to provide mechanical fixation for a plurality of end windings 1020, one or more end rings 1022 may be added, as shown in greater detail in FIG. 11. An end ring 1024 may extend into some or all of the winding slots 510, to support windings 104 positioned within the winding slots 510.

FIG. 11 shows a portion 1100 of stator 102 including end windings 1102 of stator 102, which may be the same as end windings 1020 depicted in FIG. 10. End rings 1104 provide a close fit, or an interference fit, to end windings 1102 that may limit relative motion of individual windings 104 with respect to other windings 104. Similar to manifold 112, these features may be made of base end ring material or added as a softer material with over-molding. Additionally, end rings 1104 may include orifices to control pressure in a respective in-slot fluid passage 1002 and distribute the coolant to end windings 1102 for additional cooling. Seal sleeve 1004 may be bonded to both manifold 112 and end rings 1104.

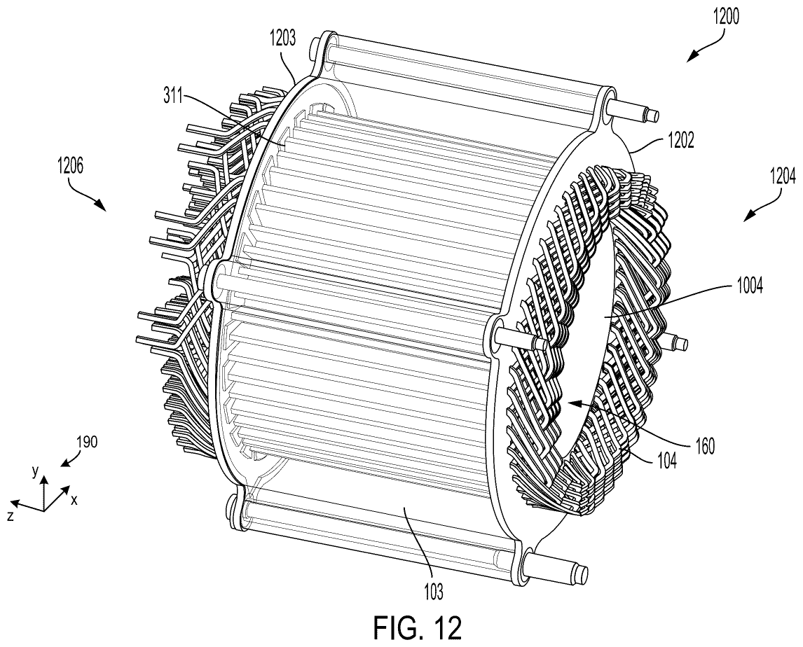

FIG. 12 shows another example 1200 of electric machine 100, including a plurality of cooling manifolds. In particular, a first end ring manifold 1202 is included on a first end 1204 of stator core 103, and a second end ring manifold 1203 is included on a second end 1206 of stator core 103, which are clamped down by bolts 302, 304, 306, and hollow bolt 110 as described above. First end ring manifold 1202 and second end ring manifold 1203 may be the same as or similar to the centrally aligned cooling manifold 112. Similar to manifold 112 and non-manifold end rings 1104, first end ring manifold 1202 and second end ring manifold 1203 may have a close or interference fit with a plurality of stator core slots 311, to prevent relative motion of the windings 104. Seal sleeve 1004 may seal against first end ring manifold 1202 and second end ring manifold 1203, preventing leakage into an air gap 160. First end ring manifold 1202 and second end ring manifold 1203 may be fed similarly to manifold 112.

However, in example 1200, the coolant may be flowed alternately to passages of first end ring manifold 1202 and second end ring manifold 1203. That is, the coolant may be flowed to every other stator core slot 311, such that each stator core slot 311 is fed by either first end ring manifold 1202 or second end ring manifold 1203. In this way, half of the stator core slots 311 are fed from first end 1204, and the other half from the second end 1206, thereby creating a cross flow (e.g., where a direction of flow of the coolant is from first end 1204 to second end 1206 for half of the slots 311, and from second end 1206 to first end 1204 for the other half of the slots 311). For slots 311 that a respective manifold does not supply coolant to, outlet features (e.g. orifices) such as end rings 1104 of FIG. 11 may be included. By integrating the manifold and end rings into two end manifolds rather than a single central manifold, manufacturing complexity of electric machine 100 may be reduced. For example, the stator core may be manufactured as one assembly rather than with two sub stacks, as described above.

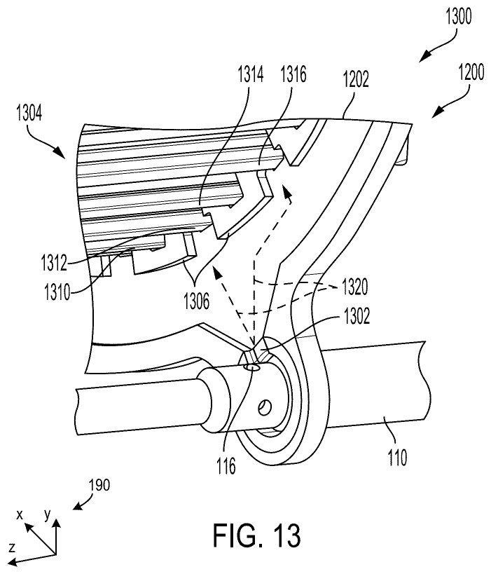

FIG. 13 shows an expanded view 1300 of first end ring manifold 1202 of example 1200, where expanded view 1300 shows how alternating windings may be cooled by alternating portions of first end ring manifold 1202. Expanded view 1300 shows a plurality of windings 1304, which may be non-limiting examples of windings 104 of FIG. 1. The plurality of windings 1304 include a first winding 1310, a second winding 1312, a third winding 1314, and a fourth winding 1316. Second winding 1312 and fourth winding 1316 are cooled by first end ring manifold 1202, while first winding 1310 and third winding 1314 are cooled by second end ring manifold 1203 (not shown in FIG. 13). That is, the coolant enters first end ring manifold 1202 from a radial hole 116 of hollow bolt 110, via an aperture 1302 (e.g., aperture 122) in first end ring manifold 1202. When the coolant enters first end ring manifold 1202, the coolant may be directed to second winding 1312 and fourth winding 1316, as indicated by arrows 1320. However, first end ring manifold 1202 may include raised portions 1306 that surround first winding 1310 and third winding 1314, which, when first end ring manifold 1202 is compressed against a respective lamination of stator 102, may prevent the coolant from circulating around first winding 1310 and third winding 1314. As a result, the coolant may not cool first winding 1310 and third winding 1314. Second end ring manifold 1203 may include similar raised portions around second winding 1312 and fourth winding 1316, such that second winding 1312 and fourth winding 1316 are not cooled by second end ring manifold 1203 (as second winding 1312 and fourth winding 1316 are cooled by first end ring manifold 1202), and second end ring manifold 1203 may not include raised portions around first winding 1310 and third winding 1314, such that first winding 1310 and third winding 1314 are cooled by second end ring manifold 1203. In this way, windings 1304 may be cooled by either first end ring manifold 1202 or second end ring manifold 1203 in an alternating fashion.

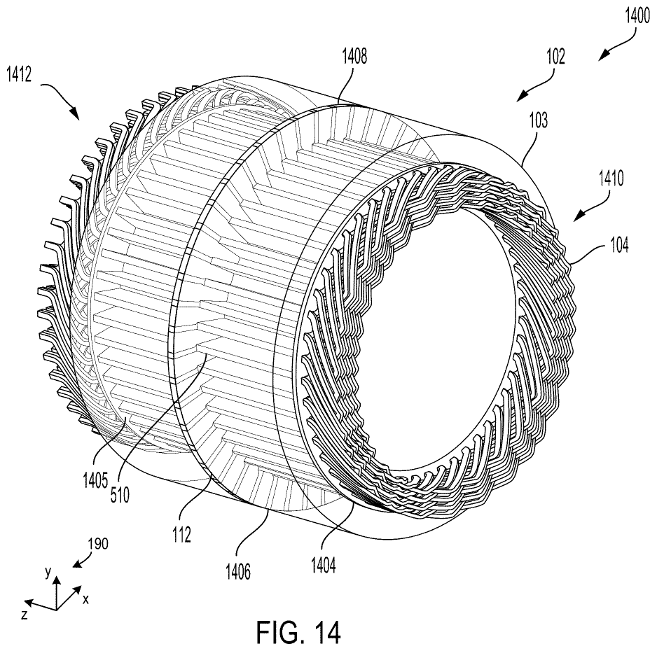

FIG. 14 shows yet another example 1400 of electric machine 100 of FIG. 1, where electric machine 100 includes a first end ring 1404 and a second end ring 1405. In example 1400, stator 102 may have an interference fit with housing 201. As a result of the interference fit, bolts 302, 304, 306, and 110 are not used to secure stator 102 to housing 201. The coolant may be flowed into cooling manifold 112 via an annular groove in housing 201, rather than via a coolant passage of a hollow bolt such as coolant passage 113 of hollow bolt 110. The annular groove may allow the coolant to flow to a plurality of radial passages 1406 of cooling manifold 112 that extend around each winding slot 510, as described above in reference to FIGS. 5 and 6.

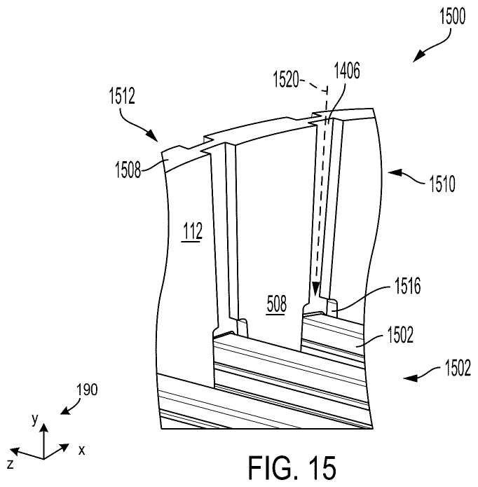

An expanded portion 1500 of example 1400 is shown in FIG. 15, where expanded portion 1500 shows an interface between cooling manifold 112 and a plurality of windings 1502, which may be the same as or similar to windings 104 of winding slots 510. The plurality of radial passages 1406 extend from an outer circumference 1508 of cooling manifold 112 into (e.g., between) different slots of windings 1502. Coolant may be directed along each radial passage 1406 to a respective winding slot 1516 as indicated by an arrow 1520, where the coolant may cool windings 1502 of the respective winding slot 1516. Radial passages 1406 may be included on both of a first side 1510 and a second side 1512 of cooling manifold 112. The number of radial passages 1406 may be one per slot 1516, as indicated in FIG. 15.

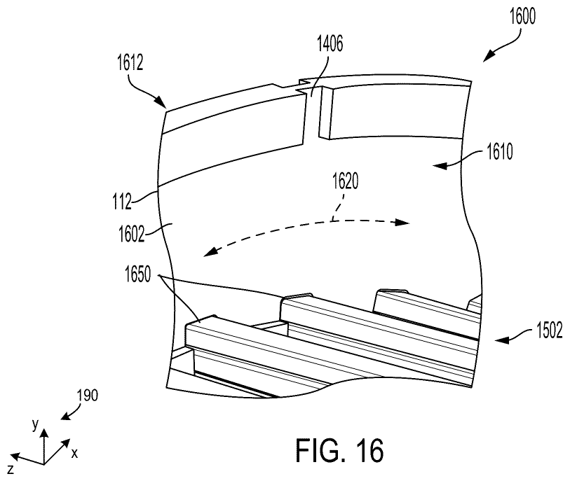

FIG. 16 shows an alternative example 1600 of electric machine 100, where a circumferential channel 1602 of cooling manifold 112 may distribute coolant to all the slots circumferentially as indicated by a bidirectional arrow 1620. In example 1600, cooling manifold 112 may include a fewer number of radial passages 1406. As with radial passages 1406, circumferential channels 1602 may be included on both of a first side 1610 and a second side 1612 of cooling manifold 112. In alternative example 1600, the coolant may be flowed between each winding 1502 via a set of passages 1650 around the windings 1502, as described above in reference to the passages 550.

In another representation, electric machine 100 may include a plurality of cooling manifolds 112, which may be positioned at various axial locations. For example, a first cooling manifold 112 may be included near a first end of stator core 103, but still between sub stacks of core laminations; and a second cooling manifold 112 may be included near a second end of stator core 103, but still between sub stacks of core laminations. In other examples, coolant may be introduced into stator 102 from one or more end manifolds (e.g., first end ring manifold 1202 and second end ring manifold 1203), and the coolant may exit stator 102 radially via a center manifold.

Thus, a cooling manifold is proposed with a hollow bolt feed solution that takes advantage of an existing bolt structure and interface to a housing of an electric machine, to create a fluid passage for routing coolant to internal portions of a stator of the electric machine. The hollow bolt creates a sealed fluid interface without the need to add an additional seal, thereby reducing manufacturing complexity of the electric machine. In-slot cooling with the manifold, or with a plurality of the manifolds, may eliminate a reliance on slot liners and varnish for limiting relative motion of windings of the stator and providing electrical isolation, while also cooling the hottest part of the electric machine, significantly influencing the machine's thermally limited capability. Additionally, by routing the coolant circumferentially and radially around the stator core slots including the windings, heat may be more efficiently and uniformly extracted from the stator than alternative cooling solutions that rely on spraying coolant on surfaces of the stator, which may not direct the coolant at the hottest, central portions of the stator. By using the hollow bolt, the proposed solution to cooling the stator does not rely on additional sealed interfaces of the electric machine, reducing manufacturing resources and maintaining the electric machine. The coolant may be introduced into the stator core without a stator interference fit, which may increase a core loss of the electric machine. Additionally, the cooling manifold provides mechanical retention of the windings of the stator.

Further, in comparison with other in-slot cooling solutions that encase the end windings in a cover/manifold flow, the proposed solution has the advantage of not relying on slot epoxy overmolding and/or end winding covers. Cold coolant may be fed directly into the hottest part of the electric machine, and rotor cooling flow can be sprayed onto the end windings for additional cooling. A pressure drop in the coolant may be reduced, due to the centrally-positioned cooling manifold crating a parallel flow split at a center of the stator.

The technical effect of cooling the electric machine by routing coolant to one or more of the proposed cooling manifolds via a hollow stator bolt is that the coolant may be directed at the hottest part of the electric machine without relying on an additional sealed coolant delivery interface with a housing of the electric machine.

FIGS. 1-16 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example.

The disclosure also provides support for a cooling system for an electric machine having a stator and a housing, the cooling system comprising: a cooling manifold positioned at an axial center of the stator and aligned coaxially with a central axis of the stator, and a bolt clamping the stator to the housing, the bolt including a hollow section comprising a fluid inlet and a fluid outlet configured to transfer a coolant from the hollow section into a plurality of passages of the cooling manifold. In a first example of the system, the hollow section includes a first portion that extends into the housing, and a second portion that extends into a stator core of the electric machine, the second portion including one or more radial holes positioned around a circumference of sides of the hollow section, the one or more radial holes positioned to allow the coolant to flow from a center passage of the hollow section to a passage between a stator core ear hole of the electric machine and an outer circumference of the hollow section. In a second example of the system, optionally including the first example, the passage is sealed to a head of the bolt and the housing by a clamping force of the bolt, and the bolt includes a lip around an outer circumference of the bolt that seals the passage at an interface between the housing and the stator core. In a third example of the system, optionally including one or both of the first and second examples, the plurality of passages of the cooling manifold are sealed against laminations of the stator core axially by a compression of a plurality of bolts including the bolt. In a fourth example of the system, optionally including one or more or each of the first through third examples, the cooling manifold is in fluid communication with the fluid outlet, and the cooling manifold comprises a partially open compression limiting eyelet of a bolt hole through which coolant is transferred from the fluid outlet of the hollow section into a radial inlet of the cooling manifold. In a fifth example of the system, optionally including one or more or each of the first through fourth examples, the compression limiting eyelet includes dowel features that extend partially into portions of a plurality of stator core slots that align the cooling manifold to the plurality of stator core slots. In a sixth example of the system, optionally including one or more or each of the first through fifth examples, the cooling manifold extends radially and inwardly into the plurality of stator core slots to form an interference fit to windings of the stator. In a seventh example of the system, optionally including one or more or each of the first through sixth examples, the cooling manifold is made from injection molded plastic, and further comprises: a first axial section that distributes the coolant circumferentially around the stator to the plurality of stator core slots at an outer circumference of the cooling manifold, a second axial section that distributes the coolant circumferentially around the stator to the plurality of stator core slots at an inner circumference of the cooling manifold, and a center axial section including a plurality of radial ribs, each radial rib a mechanical retention feature that connects the first axial section to the second axial section such that the cooling manifold can be molded as a single part. In an eighth example of the system, optionally including one or more or each of the first through seventh examples, the center axial section has an interference fit to the windings to provide mechanical support needed to prevent an outer enamel coating of the windings from rubbing on the stator core, and features of the cooling manifold that interface to the windings are made of an over-molded material softer than a material of the cooling manifold. In a ninth example of the system, optionally including one or more or each of the first through eighth examples, the cooling manifold is made of electrical steel or aluminum, and further comprises two laminated sub stacks that include alternating and connected circumferential pockets to allow the coolant to be distributed circumferentially while still maintaining a continuous lamination. In a tenth example of the system, optionally including one or more or each of the first through ninth examples, the system further comprises: a first cooling manifold positioned at a first end of the stator core, and a second cooling manifold positioned at a second end of the stator core, wherein the coolant is flowed alternately to passages of the first cooling manifold and the second cooling manifold, such that each slot of the stator core is fed by one of the first cooling manifold and the second cooling manifold.

The disclosure also provides support for a system, comprising: an electric machine including a stator, a cooling system configured to flow a coolant from a coolant pump to the stator, and a bolt coupling the cooling system to the electric machine, the bolt including a hollow section having one or more radial holes positioned around an outer circumference of the hollow section, the one or more radial holes positioned to allow the coolant to flow from the hollow section to a cooling manifold of the electric machine via a passage between a stator core ear hole of the electric machine and an outer circumference of the hollow section. In a first example of the system, the cooling manifold comprises a partially open compression limiting eyelet of a bolt hole through which coolant is transferred from the passage into a radial inlet of the cooling manifold. In a second example of the system, optionally including the first example, the cooling manifold extends radially and inwardly into a plurality of stator core slots of the stator to form an interference fit to windings of the stator. In a third example of the system, optionally including one or both of the first and second examples, the system further comprises: a seal sleeve positioned at an inner diameter of the stator to seal in-slot fluid passages of the cooling manifold from leaking coolant into a machine air gap between the stator and a rotor of the electric machine. In a fourth example of the system, optionally including one or more or each of the first through third examples, the system further comprises: a plurality of end rings positioned at end windings of the stator to provide mechanical fixation for the end windings via an interference fit to limit relative motion of the end windings, the plurality of end rings including orifices to control pressure in the in-slot fluid passages and distribute the coolant to the end windings. In a fifth example of the system, optionally including one or more or each of the first through fourth examples, the cooling manifold comprises two laminated sub stacks that include alternating and connected circumferential pockets that distribute the coolant circumferentially throughout the cooling manifold while maintaining a continuous lamination. In a sixth example of the system, optionally including one or more or each of the first through fifth examples, the electric machine comprises a first cooling manifold positioned at a first end of a stator core of the stator, and a second cooling manifold positioned at a second end of the stator core, and the coolant is flowed alternately to passages of the first cooling manifold and the second cooling manifold, such that each slot of the stator core is fed by either the first cooling manifold or the second cooling manifold.

The disclosure also provides support for a method for cooling an electric machine, the method comprising: flowing a coolant to a plurality of circumferential and radial passages of a cooling manifold positioned at an axial center of a stator of the electric machine and aligned coaxially with a central axis of the stator, via a hollow section of a bolt clamping the stator to a housing of the electric machine, the cooling manifold extending radially and inwardly into a plurality of slots of a stator core of the electric machine to form an interference fit to windings of the stator. In a first example of the method, the method further comprises: flowing the coolant from the hollow section to a passage between a stator core ear hole of the electric machine and an outer circumference of the hollow section via one or more radial holes positioned around a circumference of sides of the hollow section, the passage sealed to a head of the bolt and the housing by a clamping force of the bolt, and flowing the coolant from the passage to a radial inlet of the cooling manifold via a partially open compression limiting eyelet of a bolt hole of the cooling manifold.

In another representation, a hybrid vehicle comprises: an engine and an electric machine comprising a rotor positioned within a stator and an in-slot cooling system adapted to cool a plurality of stator wirings extending through stator slots in the stator, wherein the in-slot cooling system comprises a cooling manifold positioned at an axial center of the stator and aligned coaxially with a central axis of the stator; and a bolt clamping the stator to the housing, the bolt including a hollow section comprising a fluid inlet and a fluid outlet configured to transfer a coolant from the hollow section into a plurality of passages of the cooling manifold.

It will be appreciated that the configurations and routines disclosed herein are exemplary in nature, and that these specific examples are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A cooling system for an electric machine having a stator and a housing, the cooling system comprising:
a cooling manifold positioned at an axial center of the stator and aligned coaxially with a central axis of the stator; and
a bolt clamping the stator to the housing, the bolt including a hollow section comprising a fluid inlet and a fluid outlet configured to transfer a coolant from the hollow section into a plurality of passages of the cooling manifold.

2. The cooling system of claim 1, wherein the hollow section includes a first portion that extends into the housing, and a second portion that extends into a stator core of the electric machine, the second portion including one or more radial holes positioned around a circumference of sides of the hollow section, the one or more radial holes positioned to allow the coolant to flow from a center passage of the hollow section to a passage between a stator core ear hole of the electric machine and an outer circumference of the hollow section.

3. The cooling system of claim 2, wherein the passage is sealed to a head of the bolt and the housing by a clamping force of the bolt, and the bolt includes a lip around an outer circumference of the bolt that seals the passage at an interface between the housing and the stator core.

4. The electric machine of claim 2, wherein the plurality of passages of the cooling manifold are sealed against laminations of the stator core axially by a compression of a plurality of bolts including the bolt.

5. The cooling system of claim 2, wherein the cooling manifold is in fluid communication with the fluid outlet, and the cooling manifold comprises a partially open compression limiting eyelet of a bolt hole through which coolant is transferred from the fluid outlet of the hollow section into a radial inlet of the cooling manifold.

6. The cooling system of claim 5, wherein the compression limiting eyelet includes dowel features that extend partially into portions of a plurality of stator core slots that align the cooling manifold to the plurality of stator core slots.

7. The cooling system of claim 6, wherein the cooling manifold extends radially and inwardly into the plurality of stator core slots to form an interference fit to windings of the stator.

8. The cooling system of claim 7, wherein the cooling manifold is made from injection molded plastic, and further comprises:
a first circumferential section that distributes the coolant circumferentially around the stator to the plurality of stator core slots at an outer circumference of the cooling manifold;
a second circumferential section that distributes the coolant circumferentially around the stator to the plurality of stator core slots at an inner circumference of the cooling manifold; and
a center circumferential section including a plurality of radial ribs, each radial rib a mechanical retention feature that connects the first circumferential section to the second circumferential section such that the cooling manifold is molded as a single part.

9. The cooling system of claim 8, wherein:
the center circumferential section has an interference fit to the windings to provide mechanical support needed to prevent an outer enamel coating of the windings from rubbing on the stator core, and features of the cooling manifold that interface to the windings are made of an over-molded material softer than a material of the cooling manifold.

10. The cooling system of claim 1, wherein the cooling manifold is made of electrical steel or aluminum, and further comprises two laminated sub stacks that include alternating and connected circumferential pockets to allow the coolant to be distributed circumferentially while still maintaining a continuous lamination.

11. The electric machine of claim 2, further comprising a first cooling manifold positioned at a first end of the stator core, and a second cooling manifold positioned at a second end of the stator core, wherein the coolant is flowed alternately to passages of the first cooling manifold and the second cooling manifold, such that each slot of the stator core is fed by one of the first cooling manifold and the second cooling manifold.

12. A system, comprising:
an electric machine including a stator;
a cooling system configured to flow a coolant from a coolant pump to the stator; and
a bolt coupling the cooling system to the electric machine, the bolt including a hollow section having one or more radial holes positioned around an outer circumference of the hollow section, the one or more radial holes positioned to allow the coolant to flow from the hollow section to a cooling manifold of the electric machine via a passage between a stator core ear hole of the electric machine and an outer circumference of the hollow section.

13. The system of claim 12, wherein the cooling manifold comprises a partially open compression limiting eyelet of a bolt hole through which coolant is transferred from the passage into a radial inlet of the cooling manifold.

14. The system of claim 12, wherein the cooling manifold extends radially and inwardly into a plurality of stator core slots of the stator to form an interference fit to windings of the stator.

15. The system of claim 12, further comprising a seal sleeve positioned at an inner diameter of the stator to seal in-slot fluid passages of the cooling manifold from leaking coolant into a machine air gap between the stator and a rotor of the electric machine.

16. The system of claim 15, further comprising a plurality of end rings positioned at end windings of the stator to provide mechanical fixation for the end windings via an interference fit to limit relative motion of the end windings, the plurality of end rings including orifices to control pressure in the in-slot fluid passages and distribute the coolant to the end windings.

17. The system of claim 12, wherein the cooling manifold comprises two laminated sub stacks that include alternating and connected circumferential pockets that distribute the coolant circumferentially throughout the cooling manifold while maintaining a continuous lamination.

18. The system of claim 12, wherein the electric machine comprises a first cooling manifold positioned at a first end of a stator core of the stator, and a second cooling manifold positioned at a second end of the stator core, and the coolant is flowed alternately to passages of the first cooling manifold and the second cooling manifold, such that each slot of the stator core is fed by either the first cooling manifold or the second cooling manifold.

19. A method for cooling an electric machine, the method comprising:
flowing a coolant to a plurality of circumferential and radial passages of a cooling manifold positioned at an axial center of a stator of the electric machine and aligned coaxially with a central axis of the stator, via a hollow section of a bolt clamping the stator to a housing of the electric machine, the cooling manifold extending radially and inwardly into a plurality of slots of a stator core of the electric machine to form an interference fit to windings of the stator.

20. The method of claim 19, further comprising:
flowing the coolant from the hollow section to a passage between a stator core ear hole of the electric machine and an outer circumference of the hollow section via one or more radial holes positioned around a circumference of sides of the hollow section, the passage sealed to a head of the bolt and the housing by a clamping force of the bolt; and
flowing the coolant from the passage to a radial inlet of the cooling manifold via a partially open compression limiting eyelet of a bolt hole of the cooling manifold.
